(19) United States
(12) Patent Application Publication
(10) Pub. No.: US 2026/0032485 A1
(43) Pub. Date: Jan. 29, 2026

(54) METHOD FOR TRANSMITTING REFERENCE SIGNAL MEASUREMENT RESULT, APPARATUS AND STORAGE MEDIUM

(71) Applicant: Beijing Xiaomi Mobile Software Co., Ltd., Beijing (CN)

(72) Inventor: Ting FU, Beijing (CN)

(21) Appl. No.: 18/996,820

(22) PCT Filed: Jul. 26, 2022
(86) PCT No.: PCT/CN2022/108048

§ 371 Date: Jan. 17, 2025

(51) Int. Cl. H04W 24/10; H04L 5/00; H04L 27/26

(52) U.S. Cl. CPC H04W 24/10; H04L 5/0051; H04L 27/261

(57) ABSTRACT

A method for transmitting a reference signal measurement result, performed by user equipment, including: receiving first configuration information transmitted by a network device, where the first configuration information is configured to configure at least one first type of reference signal, and the first type of reference signal is a reference signal capable of being disabled; and transmitting a reference signal measurement result to the network device, where the reference signal measurement result includes a measurement result for at least one second type of reference signal, and the second type of reference signal is a reference signal incapable of being disabled.

### CROSS-REFERENCE TO RELATED APPLICATION

The present application is a U.S. National Stage of International Application No. PCT/CN2022/108048, filed on Jul. 26, 2022, the contents of all of which are incorporated herein by reference in their entireties for all purposes.

### BACKGROUND OF THE INVENTION

During development of the wireless communication technology, research on the reduction in energy consumption of base stations is a hot research topic. One way to reduce the energy consumption of the base stations is to dynamically enable/disable spatial units, such as some antenna units, ports, transceiver (TRX) chains, beams, panels and reference signals (RSs), etc.

### SUMMARY OF THE INVENTION

The disclosure relates to wireless communication technology, in particular to a method and apparatus for transmitting reference signal measurement result, a device, and a readable storage medium.

In a first aspect, there is provided a method for transmitting reference signal measurement result. The method is performed by user equipment, and includes:
receiving first configuration information transmitted by a network device, where the first configuration information is configured to configure at least one first type of reference signal, and the first type of reference signal is a reference signal capable of being disabled; and
transmitting a reference signal measurement result to the network device, where the reference signal measurement result includes a measurement result for at least one second type of reference signal, and the second type of reference signal is a reference signal incapable of being disabled.

In a second aspect, there is provided a method for receiving reference signal measurement result. The method is performed by a network device, and includes:
transmitting first configuration information to user equipment, where the first configuration information is configured to configure at least one first type of reference signal, and the first type of reference signal is a reference signal capable of being disabled; and
receiving a reference signal measurement result transmitted by the user equipment, where the reference signal measurement result includes a measurement result for at least one second type of reference signal, and the second type of reference signal is a reference signal incapable of being disabled.

In a third aspect, there is provided an apparatus for transmitting reference signal measurement result. The apparatus is configured for user equipment, and includes a transceiving module. The transceiving module is configured to receive first configuration information transmitted by a network device, where the first configuration information is configured to configure at least one first type of reference signal, and the first type of reference signal is a reference signal capable of being disabled. The transceiving module is further configured to transmit a reference signal measurement result to the network device, where the reference signal measurement result includes a measurement result for at least one second type of reference signal, and the second type of reference signal is a reference signal incapable of being disabled.

In a fourth aspect, there is provided an apparatus for receiving reference signal measurement result. The apparatus is configured for a network device, and includes a transceiving module. The transceiving module is configured to transmit first configuration information to user equipment, where the first configuration information is configured to configure at least one first type of reference signal, and the first type of reference signal is a reference signal capable of being disabled. The transceiving module is further configured to receive a reference signal measurement result transmitted by the user equipment, where the reference signal measurement result includes a measurement result for at least one second type of reference signal, and the second type of reference signal is a reference signal incapable of being disabled.

In a fifth aspect, there is provided an electronic device. The electronic device includes a processor and a memory. The memory is configured to store a computer program. The processor is configured to execute the computer program, so as to implement the first aspect or any possible design in the first aspect.

In a sixth aspect, there is provided an electronic device. The electronic device includes a processor and a memory. The memory is configured to store a computer program. The processor is configured to execute the computer program, so as to implement the second aspect or any possible design in the second aspect.

In a seventh aspect, there is provided a non-transitory computer-readable storage medium. The non-transitory computer-readable storage medium stores an instruction, where the instruction, when invoked and executed by a computer, causes the computer to execute the first aspect or any possible design in the first aspect.

In an eighth aspect, there is provided a non-transitory computer-readable storage medium. The non-transitory computer-readable storage medium stores an instruction, where the instruction, when invoked and executed by a computer, causes the computer to execute the second aspect or any possible design in the second aspect.

### BRIEF DESCRIPTION OF DRAWINGS

Accompanying drawings described are used for providing further understanding of examples of the disclosure as a constituent part of the disclosure. Examples of the disclosure and their descriptions are used to explain the examples of the disclosure, rather than constitute improper limitation to the examples of the disclosure. In the figures:

The accompanying drawings are incorporated into the description as a constituent part of the description, illustrate examples conforming to the examples of the disclosure, and serve to explain principles of the example of the disclosure along with the description.

FIG. 1 is a schematic architecture diagram of a wireless communication system according to an example of the disclosure.

FIG. 2 is a schematic diagram of a method for transmitting reference signal measurement result according to an example.

FIG. 3 is a flowchart of a method for transmitting reference signal measurement result according to an example.

FIG. 4 is a flowchart of another method for transmitting reference signal measurement result according to an example.

FIG. 5 is a flowchart of yet another method for transmitting reference signal measurement result according to an example.

FIG. 6 is a flowchart of yet another method for transmitting reference signal measurement result according to an example.

FIG. 7 is a flowchart of yet another method for transmitting reference signal measurement result according to an example.

FIG. 8 is a flowchart of yet another method for transmitting reference signal measurement result according to an example.

FIG. 9 is a flowchart of yet another method for transmitting reference signal measurement result according to an example.

FIG. 10 is a flowchart of yet another method for transmitting reference signal measurement result according to an example.

FIG. 11 is a flowchart of still another method for transmitting reference signal measurement result according to an example.

FIG. 12 is a flowchart of a method for receiving reference signal measurement result according to an example.

FIG. 13 is a flowchart of another method for receiving reference signal measurement result according to an example.

FIG. 14 is a flowchart of yet another method for receiving reference signal measurement result according to an example.

FIG. 15 is a flowchart of yet another method for receiving reference signal measurement result according to an example.

FIG. 16 is a flowchart of still another method for receiving reference signal measurement result according to an example.

FIG. 17 is a structural diagram of an apparatus for transmitting reference signal measurement result according to an example.

FIG. 18 is a structural diagram of an apparatus for receiving reference signal measurement result according to an example.

FIG. 19 is a structural diagram of another apparatus for transmitting reference signal measurement result according to an example.

FIG. 20 is a structural diagram of another apparatus for receiving reference signal measurement result according to an example.

### DETAILED DESCRIPTION OF THE INVENTION

Examples of the disclosure will be further described with reference to accompanying drawings and in conjunction with embodiments.

Examples will be described in detail, and their instances are shown in the accompanying drawings. When the following description involves the accompanying drawings, the same numerals in different accompanying drawings indicate the same or similar elements unless otherwise indicated. Embodiments described in the following examples do not denote all embodiments consistent with the examples of the disclosure. On the contrary, these embodiments are instances of apparatuses and methods consistent with some aspects of the disclosure as detailed in the appended claims.

Terms used in the examples of the disclosure are used for describing examples rather than limiting the examples of the disclosure. Singular forms such as “a”, “an”, “the” and “this” used in examples and the appended claims of the disclosure are also intended to include plural forms, unless otherwise clearly stated in the context. It is also to be understood that the term “and/or” used in the disclosure indicates and includes any or all possible combinations of one or more of associated listed items.

It is to be understood that although terms such as first, second and third can be used in the examples of the disclosure to describe different types of information, the information is not to be limited to these terms. These terms are used for distinguishing the same type of information from each other. For example, first information can also be referred to as second information and the second information can also be referred to as the first information similarly without departing from the scope of examples of the disclosure. Depending on the context, the word “if” as used in the disclosure can be interpreted as “at the time of” or “when” or “in response to determining”.

The examples of the disclosure are described in detail below, and instances of the examples are shown in the accompanying drawings, throughout which identical or similar reference numerals indicate identical or similar elements. The examples described below with reference to the accompanying drawings are illustrative and are intended to explain the disclosure, but is not to be construed as limitation to the disclosure.

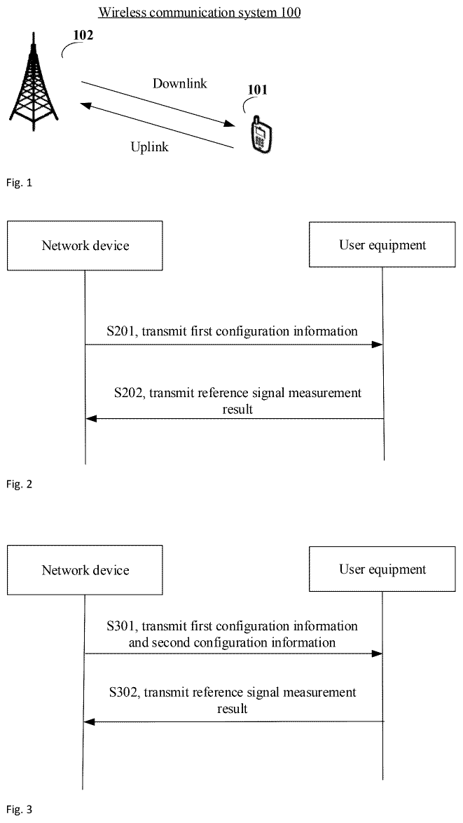

As shown in FIG. 1, a method for transmitting a reference signal measurement result according to an example of the disclosure may be applied to a wireless communication system 100. The wireless communication system 100 may include, but is not limited to, a network device 102 and user equipment 101. The user equipment 101 is configured to support carrier aggregation. The user equipment 101 may be connected to a plurality of carrier units of the network device 102, and the plurality of carrier units include a primary carrier unit and one or more secondary carrier units.

It is to be understood that the wireless communication system 100 may be applied to a low-frequency scenario and a high-frequency scenario. The application scenarios of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-Generation (5G) system, a new radio (NR) communication system, and a future evolved public land mobile network (PLMN) system.

The user equipment 101 may be user equipment (UE), a terminal, an access terminal, a terminal unit, a terminal station, a mobile station (MS), a remote station, a remote terminal, a mobile terminal, a wireless communication device, a terminal agent or user equipment. The user equipment 101 may have a wireless transceiving function, and may communicate (for example, wirelessly communicate) with one or more network devices 102 of one or more communication systems and receive a network service provided by the network device 102. The network device 101 includes, but is not limited to, a base station shown in the figure.

The user equipment 101 may be a cellular phone, a cordless phone, a session initiation protocol (SIP) phone, a wireless local loop (WLL) station, a personal digital assistant (PDA) device, a handheld device with a wireless communication function, a computation device or other processing devices connected to a wireless modem, a vehicle-mounted device, a wearable device, user equipment in a future 5G network, user equipment in a future evolved PLMN, etc.

The network device 102 may be an access network device (or referred to as an access network site). The access network device refers to a device that provides a network access function, such as a radio access network (RAN) base station. The network device 102 may include a base station (BS) device, or include a base station device and a radio resource management device for controlling the base station device. The network device 102 may also include a relay station (a relay device), an access point, a base station in the future 5G network, a base station in the future evolved PLMN, or a NR base station. The network device 102 may be a wearable device or a vehicle-mounted device. The network device 102 may also be a communication chip with a communication module.

For example, the network device 102 includes, but is not limited to, a gnodeB (gNB) in the 5G system, an evolved node B (eNB) and a radio network controller (RNC) in the LTE system, node B (NB) in a wideband code division multiple access (WCDMA) system, a radio controller and a base station controller (BSC) in the CRAN system, a base transceiver station (BTS), a home base station (for example, home evolved nodeB, or home node B (HNB)), a baseband unit (BBU), a transmitting and receiving point (TRP), a transmitting point (TP) and a mobile switching center in a global system for mobile communications (GSM) or a code division multiple access (CDMA) system.

During development of the wireless communication technology, research on the reduction in energy consumption of base stations is a hot research topic. One way to reduce the energy consumption of the base stations is to dynamically enable/disable spatial units, such as some antenna units, ports, transceiver (TRX) chains, beams, panels and reference signals (RSs), etc. However, dynamically enabling/disabling the spatial units may lead to change in an actually transmitted reference signal.

In some embodiments, during downlink reference signal measurement, a network device configures a reference-signal-to-be-measured for user equipment, and the user equipment obtains a measurement result by measuring the reference-signal-to-be-measured, and reports information indicating the measurement result to the network device. During downlink beam measurement, each piece of information includes a reference signal indication (such as a channel state information-reference signal (CSI-RS) index and a synchronization signal block (SSB) index) and layer 1-reference signal receiving power (L1-RSRP) or layer 1-signal to interference plus noise ratio (L1-SINR) information corresponding to the reference signal.

In a case that a reference signal corresponding to at least one measurement result in the information indicating the measurement result reported by the user equipment is dynamically disabled by the network device in a subsequent process, the network device only can indicate for the user equipment another reference signal that is not disabled for data transmission. However, since the user equipment might not report a measurement result for this reference signal that is not disabled, the network device is unable to determine a reference signal for the data transmission.

An example of the disclosure provides a method for transmitting reference signal measurement result. FIG. 2 is a flowchart of a method for transmitting reference signal measurement result according to an example. As shown in FIG. 2, the method includes steps S201 and S202.

In step S201, a network device transmits first configuration information to user equipment.

The first configuration information is configured to configure at least one first type of reference signal. The first type of reference signal is a reference signal capable of being disabled. The reference signal capable of being disabled is a reference signal to be dynamically disabled by the network device in a subsequent data transmission process. The number of the reference signals capable of being disabled is greater than or equal to 1.

In some examples, the first configuration information is configured to configure at least one spatial unit group. The spatial unit group is a candidate spatial unit group capable of being disabled. The spatial unit group includes at least one first type of reference signal.

The user equipment determines the reference signal capable of being disabled, that is, the first type of reference signal, according to a received candidate spatial unit group capable of being disabled.

In step S202, the user equipment transmits a reference signal measurement result to the network device.

The reference signal measurement result includes a measurement result for at least one second type of reference signal. The second type of reference signal is a reference signal incapable of being disabled. The reference signal incapable of being disabled is a reference signal not to be dynamically disabled by the network device in the subsequent data transmission process. The reference signal measurement result includes a measurement result for at least one reference signal incapable of being disabled. For example, the measurement result may be layer 1-reference signal receiving power (L1-RSRP) or may be layer 1-signal to interference plus noise ratio (L1-SINR).

In some examples, the measurement result for each second type of reference signal in the reference signal measurement result is greater than a set value.

The set value may be an empirical value. The reference signal measurement result transmitted by the user equipment to the network device merely includes a measurement result greater than the set value.

For example, the reference-signal-to-be-measured includes N second type of reference signals. Measurement results for M second type of reference signals are greater than the set value. In a case that M is greater than or equal to 1, the user equipment transmits the measurement results for the M second type of reference signals to the network device. In a case that M is equal to 0, the user equipment does not transmit the measurement result for the second type of reference signal to the network device, and the user equipment transmits the measurement result for the first type of reference signal to the network device in this case.

In the example of the disclosure, the network device informs the user equipment of the reference signal capable of being disabled, and the user equipment can select and measure at least one reference signal incapable of being disabled when measuring the reference signal, and report a measurement result that satisfies a requirement to the network device. Thus, after executing an operation of disabling the reference signal, the network device can select, according to the measurement result, at least one reference signal for data transmission from the reference signals incapable of being disabled, preventing the operation of disabling the reference signal from influencing the data transmission.

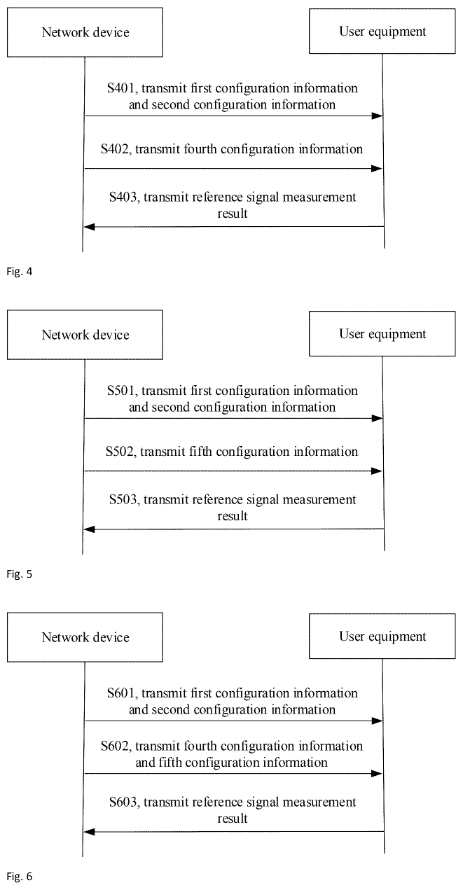

An example of the disclosure provides a method for transmitting reference signal measurement result. FIG. 3 is a flowchart of a method for transmitting reference signal measurement result according to an example. As shown in FIG. 3, the method includes steps S301 and S302.

In step S301, a network device transmits first configuration information and second configuration information to user equipment.

The first configuration information is configured to configure at least one first type of reference signal. The second configuration information is configured to configure a reference-signal-to-be-measured. The reference-signal-to-be-measured includes at least one first type of reference signal and at least one second type of reference signal.

The first type of reference signal is a reference signal capable of being disabled. The reference signal capable of being disabled is a reference signal to be dynamically disabled by the network device in a subsequent data transmission process. The number of the reference signals capable of being disabled is greater than or equal to 1.

The second type of reference signal is a reference signal incapable of being disabled. The reference signal incapable of being disabled is a reference signal not to be dynamically disabled by the network device in the subsequent data transmission process.

In some examples, the first configuration information is configured to configure at least one spatial unit group. The spatial unit group is a candidate spatial unit group capable of being disabled. The spatial unit group includes at least one first type of reference signal.

The network device configures for the user equipment, through the second configuration information, the reference-signal-to-be-measured including at least one reference signal incapable of being disabled. The user equipment determines, according to the received candidate spatial unit group capable of being disabled and the received second configuration information, the first type of reference signal and the second type of reference signal in the reference-signal-to-be-measured.

In step S302, the user equipment transmits a reference signal measurement result to the network device.

The reference signal measurement result includes a measurement result for at least one second type of reference signal. For example, the measurement result may be L1-RSRP or may be L1-SINR.

In some examples, the measurement result for each second type of reference signal in the reference signal measurement result is greater than a set value.

The set value is an empirical value. The reference signal measurement result transmitted by the user equipment to the network device merely includes a measurement result greater than the set value.

For example, the reference-signal-to-be-measured includes N second type of reference signals. Measurement results for M second type of reference signals are greater than the set value. In a case that M is greater than or equal to 1, the user equipment transmits the measurement results for the M second type of reference signals to the network device. In a case that M is equal to 0, the user equipment does not transmit the measurement result for the second type of reference signal to the network device, and the user equipment merely transmits the measurement result for the first type of reference signal to the network device in this case.

In the example of the disclosure, the user equipment is informed of the reference signal capable of being disabled in the reference-signal-to-be-measured according to the first configuration information and the second configuration information, and can select and measure at least one reference signal incapable of being disabled when measuring the reference signal, and report a measurement result that satisfies a requirement to the network device. Thus, after executing an operation of disabling the reference signal, the network device can select, according to the measurement result, at least one reference signal for data transmission from the reference signals incapable of being disabled, preventing the operation of disabling the reference signal from influencing the data transmission.

In another example, before step S302, the method further includes transmitting third configuration information to the user equipment by the network device. The third configuration information is configured to configure the number of reference signals in the reference signal measurement result transmitted by the user equipment. The number of the reference signals in the reference signal measurement result is greater than 1, and the reference signals include at least one of the first type of reference signal or the second type of reference signal. That is, the network device indicates to the user equipment a total number of all reference signals included in the measurement result to be reported by the user equipment. Such reference signals include at least one of the first type of reference signal or the second type of reference signal. The third configuration information does not limit the type of such reference signals.

For a case that the number of the reference signals in the reference signal measurement result transmitted by the user equipment is equal to 1 as configured by the network device, the user equipment generally needs to feed back a measurement result for an optimal beam, so as to optimize real-time scheduling. It is not specified that the measurement result for the second type of reference signal must be fed back.

An example of the disclosure provides a method for transmitting a reference signal measurement result. FIG. 4 is a flowchart of another method for transmitting a reference signal measurement result according to an example. As shown in FIG. 4, the method includes steps S401, S402 and S403.

In step S401, a network device transmits first configuration information and second configuration information to user equipment.

Step S401 has the same contents as step S301, and will not be repeated.

In step S402, the network device transmits fourth configuration information to the user equipment.

The fourth configuration information is configured to configure the number of the second type of reference signals in a measurement result for the second type of reference signal in the reference signal measurement result.

In some examples, the number of the second type of reference signals in the measurement result for the second type of reference signal in the reference signal measurement result is L, and the number of the reference-signals-to-be-measured is K, where a range of L is:

$$1 \leq L \leq K .$$

The number of the second type of reference signals is determined by a plurality of methods. For example, the number of the second type of reference signals is determined according to the number of the reference-signals-to-be-measured and according to a set relation.

In an example, the set relation may be a linear functional relation. Alternatively, the set relation may be a nonlinear functional relation. Alternatively, the set relation is a one-to-one mapping relation. For example, K may equal 1 or 2 or 3 or 4, and when K=2 or 3, L=1; and when K=4, L=2.

In step S403, the user equipment transmits a reference signal measurement result to the network device.

The reference signal measurement result includes a measurement result for at least one second type of reference signal. The number of the second type of reference signals in the measurement result for at least one second type of reference signal is the number indicated by the fourth configuration information.

In some examples, the measurement result for each second type of reference signal in the reference signal measurement result is greater than a set value. The set value is an empirical value. The reference signal measurement result transmitted by the user equipment to the network device merely includes a measurement result greater than the set value, and the number of the reference signals is the number indicated by the fourth configuration information.

An example of the disclosure provides a method for transmitting reference signal measurement result. FIG. 5 is a flowchart of yet another method for transmitting reference signal measurement result according to an example. As shown in FIG. 5, the method includes steps S501, S502 and S503.

In step S501, a network device transmits first configuration information and second configuration information to user equipment.

Step S501 has the same contents as step S301, and will not be repeated.

In step S502, the network device transmits fifth configuration information to the user equipment.

The fifth configuration information is configured to configure a report manner. The report manner is a report manner of the reference signal measurement result based on a reference signal group.

In step S503, the user equipment transmits a reference signal measurement result to the network device.

In some examples, in response to the fifth configuration information, the reference-signals-to-be-measured are divided into two reference signal groups according to the number of the reference-signals-to-be-measured. The measurement result reported includes a measurement result for at least one reference signal group. For example, a measurement result for one reference signal group is reported, or measurement results for two reference signal groups are reported. The reported measurement result for the reference signal group includes a measurement result for at least one second type of reference signal.

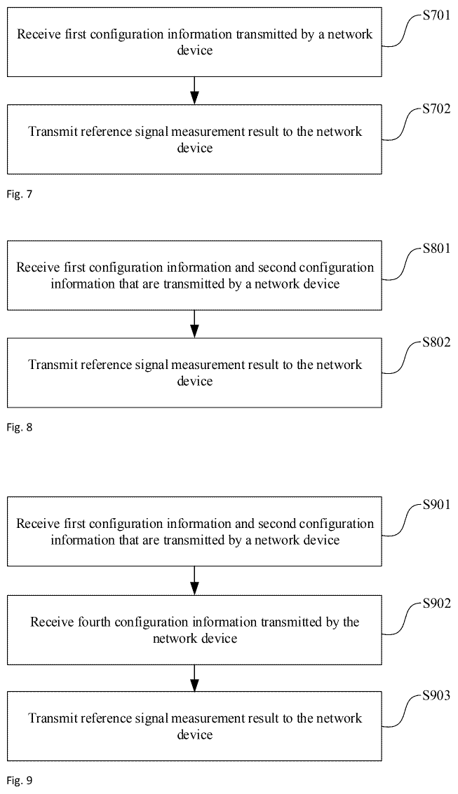

An example of the disclosure provides a method for transmitting reference signal measurement result. FIG. 6 is a flowchart of yet another method for transmitting reference signal measurement result according to an example. As shown in FIG. 6, the method includes steps S601, S602 and S603.

In step S601, a network device transmits first configuration information and second configuration information to user equipment.

Step S601 has the same contents as step S301, and will not be repeated.

In step S602, the network device transmits fourth configuration information and fifth configuration information to the user equipment.

The fourth configuration information is configured to configure the number of second type of reference signals in a measurement result for the second type of reference signal in the reference signal measurement result. The fifth configuration information is configured to configure a report manner.

In some examples, the number of the second type of reference signals in the measurement result for the second type of reference signal in the reference signal measurement result is L, and the number of the reference-signals-to-be-measured is K, where a range of L is:

$$1 \leq L \leq K .$$

methods. For example, the number of the second type of reference signals is determined according to the number of the reference-signals-to-be-measured and according to a set relation.

In an example, the set relation may be a linear functional relation. Alternatively, the set relation may be a nonlinear functional relation. Alternatively, the set relation is a one-to-one mapping relation. For example, K may equal 1 or 2 or 3 or 4, and when K=2 or 3, L=1; and when K=4, L=2.

The fifth configuration information is configured to configure a report manner. The report manner is a report manner of the reference signal measurement result based on a reference signal group.

In step S603, the user equipment transmits a reference signal measurement result to the network device.

In some examples, in response to the fifth configuration information, the reference-signals-to-be-measured are divided into two reference signal groups according to the number of the reference-signals-to-be-measured. The measurement result reported includes a measurement result for at least one reference signal group. For example, a measurement result for one reference signal group is reported, or measurement results for two reference signal groups are reported. The reported measurement result for the reference signal group includes a measurement result for at least one second type of reference signal. The number of the second type of reference signal is the number indicated by the fourth configuration information.

A plurality of pieces of configuration information, such as the first configuration information, the second configuration information, the third configuration information, the fourth configuration information and the fifth configuration information are involved in the above examples. Different configuration information may be configured in the same signaling (or message), or may be configured by using different signaling (or messages) respectively. For example, the above five pieces of configuration information may be configured in the same signaling (or message), or may be configured by using different signaling (or messages) respectively. For example, at least two pieces of the five pieces of configuration information may be configured in the same signaling (or message), or may be configured by using different signaling (or messages) respectively.

An example of the disclosure provides a method for transmitting reference signal measurement result, and the method is performed by user equipment. FIG. 7 is a flowchart of yet another method for transmitting reference signal measurement result according to an example. As shown in FIG. 7, the method includes steps S701 and S702.

In step S701, first configuration information transmitted by a network device is received.

The first configuration information is configured to configure at least one first type of reference signal. The first type of reference signal is a reference signal capable of being disabled.

The reference signal capable of being disabled is a reference signal to be dynamically disabled by the network device in a subsequent data transmission process. The number of the reference signals capable of being disabled is greater than or equal to 1.

In some examples, the first configuration information is configured to configure at least one spatial unit group. The spatial unit group is a candidate spatial unit group capable of being disabled. The spatial unit group includes at least one first type of reference signal.

The user equipment determines the reference signal capable of being disabled, that is, the first type of reference signal, according to the received candidate spatial unit group capable of being disabled.

In step S702, a reference signal measurement result is transmitted to the network device.

The reference signal measurement result includes a measurement result for at least one second type of reference signal. The second type of reference signal is a reference signal incapable of being disabled.

The reference signal incapable of being disabled is a reference signal not to be dynamically disabled by the network device in the subsequent data transmission process. The reference signal measurement result includes the measurement result for at least one reference signal incapable of being disabled.

For example, the measurement result may be L1-RSRP or may be L1-SINR.

In some examples, the measurement result for each second type of reference signal in the reference signal measurement result is greater than a set value.

The set value may be an empirical value. The reference signal measurement result transmitted to the network device merely includes a measurement result greater than the set value.

For example, the reference-signal-to-be-measured includes N second type of reference signals. Measurement results for M second type of reference signals are greater than the set value. In a case that M is greater than or equal to 1, the user equipment transmits the measurement results for the M second type of reference signals to the network device. In a case that M is equal to 0, the user equipment does not transmit the measurement result for the second type of reference signal to the network device, and the user equipment transmits the measurement result for the first type of reference signal to the network device in this case.

In the example of the disclosure, the user equipment is informed of, according to the first configuration information, the reference signal capable of being disabled, and can select and measure at least one reference signal incapable of being disabled when measuring the reference signal, and report a measurement result that satisfies a requirement to the network device. Thus, after executing an operation of disabling the reference signal, the network device can select, according to the measurement result, at least one reference signal for data transmission from the reference signals incapable of being disabled, preventing the operation of disabling the reference signal from influencing the data transmission.

An example of the disclosure provides a method for transmitting reference signal measurement result, and the method is performed by user equipment. FIG. 8 is a flowchart of yet another method for transmitting reference signal measurement result according to an example. As shown in FIG. 8, the method includes steps S801 and S802.

In step S801, first configuration information and second configuration information that are transmitted by a network device are received.

The first configuration information is configured to configure at least one first type of reference signal. The first type of reference signal is a reference signal capable of being disabled. The second configuration information is configured to configure a reference-signal-to-be-measured. The reference-signal-to-be-measured includes at least one first type of reference signal and at least one second type of reference signal.

The reference signal capable of being disabled is a reference signal to be dynamically disabled by the network device in a subsequent data transmission process. The number of the reference signals capable of being disabled is greater than or equal to 1.

In some examples, the first configuration information is configured to configure at least one spatial unit group. The spatial unit group is a candidate spatial unit group capable of being disabled. The spatial unit group includes at least one first type of reference signal.

It is to determine, according to the reference-signal-to-be-measured in the received second configuration information and the received candidate spatial unit group capable of being disabled, the reference signal capable of being disabled, that is, the first type of reference signal, in the reference-signal-to-be-measured.

In step S802, a reference signal measurement result is transmitted to the network device.

The reference signal measurement result includes a measurement result for at least one second type of reference signal. The second type of reference signal is a reference signal incapable of being disabled.

The reference signal incapable of being disabled is a reference signal not to be dynamically disabled by the network device in the subsequent data transmission process. The reference signal measurement result includes the measurement result for at least one reference signal incapable of being disabled.

For example, the measurement result may be L1-RSRP or may be L1-SINR.

In some examples, the measurement result for each second type of reference signal in the reference signal measurement result is greater than a set value.

The set value may be an empirical value. The reference signal measurement result transmitted to the network device merely includes a measurement result greater than the set value.

For example, the reference-signal-to-be-measured includes N second type of reference signals. Measurement results for M second type of reference signals are greater than the set value. In a case that M is greater than or equal to 1, the user equipment transmits the measurement results for the M second type of reference signals to the network device. In a case that M is equal to 0, the user equipment does not transmit the measurement result for the second type of reference signal to the network device, and the user equipment transmits the measurement result for the first type of reference signal to the network device in this case.

In the example of the disclosure, the user equipment is informed of the reference signal capable of being disabled in the reference-signal-to-be-measured according to the first configuration information and the second configuration information, and can select and measure at least one reference signal incapable of being disabled when measuring the reference signal, and report a measurement result that satisfies a requirement to the network device. Thus, after executing an operation of disabling the reference signal, the network device can select, according to the measurement result, at least one reference signal for data transmission from the reference signals incapable of being disabled, preventing the operation of disabling the reference signal from influencing the data transmission.

In another example, before step S802, the method further includes receiving third configuration information transmitted by the network device. The third configuration information is configured to configure the number of reference signals in the reference signal measurement result transmitted by the user equipment. The number of the reference signals in the reference signal measurement result is greater than 1, and the reference signals include at least one of the first type of reference signal or the second type of reference signal. That is, the network device indicates to the user equipment the number of all reference signals included in the measurement result to be reported by the user equipment irrespective of the type of such reference signals.

An example of the disclosure provides a method for transmitting reference signal measurement result, and the method is performed by user equipment. FIG. 9 is a flowchart of yet another method for transmitting reference signal measurement result according to an example. As shown in FIG. 9, the method includes steps S901, S902 and S903.

In step S901, first configuration information and second configuration information that are transmitted by a network device are received.

Step S901 has the same contents as step S801, and will not be repeated.

In step S902, fourth configuration information transmitted by the network device is received.

The fourth configuration information is configured to configure the number of the second type of reference signals in a measurement result for the second type of reference signal in the reference signal measurement result.

In some examples, the number of the second type of reference signals in the measurement result for the second type of reference signal in the reference signal measurement result is L, and the number of the reference-signals-to-be-measured is K, where a range of L is:

$$1 \leq L \leq K .$$

The number of the second type of reference signals is determined by a plurality of methods. For example, the number of the second type of reference signals is determined according to the number of the reference-signals-to-be-measured and according to a set relation.

In an example, the set relation may be a linear functional relation. Alternatively, the set relation may be a nonlinear functional relation. Alternatively, the set relation is a one-to-one mapping relation. For example, K may equal 1 or 2 or 3 or 4, and when K=2 or 3, L=1; and when K=4, L=2.

In step S903, a reference signal measurement result is transmitted to the network device.

The reference signal measurement result includes the measurement result for at least one second type of reference signal. The number of the second type of reference signals in the measurement result for at least one second type of reference signal is the number indicated by the fourth configuration information.

In some examples, the measurement result for each second type of reference signal in the reference signal measurement result is greater than a set value. The set value is an empirical value. The reference signal measurement result transmitted by the user equipment to the network device merely includes a measurement result greater than the set value, and the number of the reference signals is the number indicated by the fourth configuration information.

An example of the disclosure provides a method for transmitting reference signal measurement result. FIG. 10 is a flowchart of yet another method for transmitting reference signal measurement result according to an example. As shown in FIG. 10, the method includes steps S1001, S1002, and S1003.

In step S1001, first configuration information and second configuration information that are transmitted by a network device are received.

Step S1001 has the same contents as step S801, and will not be repeated.

In step S1002, fifth configuration information transmitted by the network device is received.

The fifth configuration information is configured to configure a report manner. The report manner is a report manner of a reference signal measurement result based on a reference signal group.

In step S1003, a reference signal measurement result is transmitted to the network device.

In some examples, in response to the fifth configuration information, the reference-signals-to-be-measured are divided into two reference signal groups according to the number of the reference-signals-to-be-measured. The measurement result reported includes a measurement result for at least one reference signal group. For example, a measurement result for one reference signal group is reported, or measurement results for two reference signal groups are reported. The reported measurement result for the reference signal group includes a measurement result for at least one second type of reference signal.

An example of the disclosure provides a method for transmitting reference signal measurement result, and the method is performed by user equipment. FIG. 11 is a flowchart of still another method for transmitting reference signal measurement result according to an example. As shown in FIG. 11, the method includes steps S1101, S1102 and S1103.

In step S1101, first configuration information and second configuration information that are transmitted by a network device are received.

Step S1101 has the same contents as step S801, and will not be repeated.

In step S1102, fourth configuration information and fifth configuration information that are transmitted by the network device are received.

The fourth configuration information is configured to configure the number of the second type of reference signals in a measurement result for the second type of reference signal in the reference signal measurement result. The fifth configuration information is configured to configure a report manner.

In some examples, the number of the second type of reference signals in the measurement result for the second type of reference signal in the reference signal measurement result is L, and the number of the reference-signals-to-be-measured is K, where a range of L is:

$$1 \leq L \leq K .$$

The number of the second type of reference signals is determined by a plurality of methods. For example, the number of the second type of reference signals is determined according to the number of the reference-signals-to-be-measured and according to a set relation.

In an example, the set relation may be a linear functional relation. Alternatively, the set relation may be a nonlinear functional relation. Alternatively, the set relation is a one-to-one mapping relation. For example, K may equal 1 or 2 or 3 or 4, and when K=2 or 3, L=1; and when K=4, L=2.

In some examples, the report manner is a report manner of the reference signal measurement result based on a reference signal group.

In step S1103, a reference signal measurement result is transmitted to the network device.

In some examples, in response to the fifth configuration information, the reference-signals-to-be-measured are divided into two reference signal groups according to the number of the reference-signals-to-be-measured. The measurement result reported includes a measurement result for at least one reference signal group. For example, a measurement result for one reference signal group is reported, or measurement results for two reference signal groups are reported. The reported measurement result for the reference signal group includes a measurement result for at least one second type of reference signal, and the number of the second type of reference signals is the number indicated by the fourth configuration information.

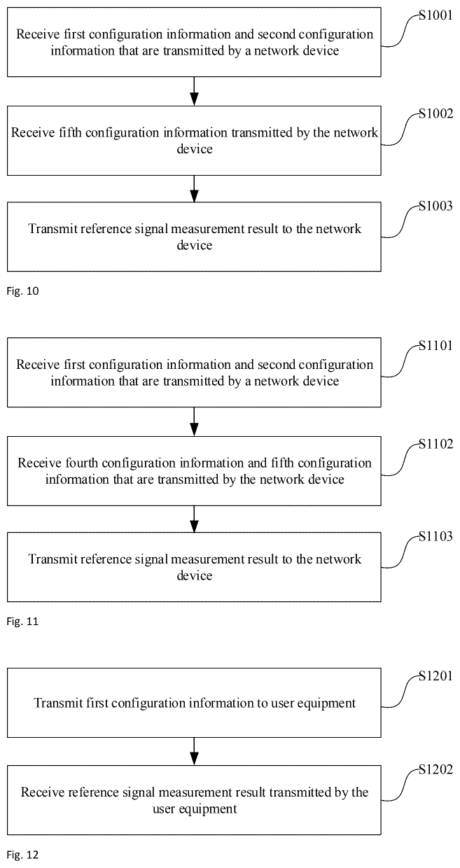

An example of the disclosure provides a method for receiving reference signal measurement result, and the method is performed by a network device. FIG. 12 is a flowchart of a method for receiving reference signal measurement result according to an example. As shown in FIG. 12, the method includes steps S1201 and S1202.

In step S1201, first configuration information is transmitted to user equipment.

The first configuration information is configured to configure at least one first type of reference signal. The first type of reference signal is a reference signal capable of being disabled.

The reference signal capable of being disabled is a reference signal to be dynamically disabled by the network device in a subsequent data transmission process. The number of the reference signals capable of being disabled is greater than or equal to 1.

In some examples, the first configuration information is configured to configure at least one spatial unit group. The spatial unit group is a candidate spatial unit group capable of being disabled. The spatial unit group includes at least one first type of reference signal.

The user equipment determines the reference signal capable of being disabled, that is, the first type of reference signal, according to the received candidate spatial unit group capable of being disabled.

In step S1202, a reference signal measurement result transmitted by the user equipment is received.

The reference signal measurement result includes a measurement result for at least one second type of reference signal. The second type of reference signal is a reference signal incapable of being disabled.

The reference signal incapable of being disabled is a reference signal not to be dynamically disabled by the network device in the subsequent data transmission process. The reference signal measurement result includes the measurement result for at least one reference signal incapable of being disabled.

For example, the measurement result may be L1-RSRP or may be L1-SINR.

In some examples, the measurement result for each second type of reference signal in the reference signal measurement result is greater than a set value. The set value may be an empirical value. The reference signal measurement result received by the network device merely includes a measurement result greater than the set value.

In the example of the disclosure, the network device informs, through the first configuration information, the user equipment of the reference signal capable of being disabled, such that the user equipment can select and measure at least one reference signal incapable of being disabled when measuring the reference signal, and report a measurement result that satisfies a requirement to the network device. The network device can select at least one reference signal for data transmission from the reference signals incapable of being disabled after executing, after receiving the measurement result, an operation of disabling the reference signal, preventing the operation of disabling the reference signal from influencing the data transmission.

An example of the disclosure provides a method for receiving reference signal measurement result, and the method is performed by a network device. FIG. 13 is a flowchart of another method for receiving reference signal measurement result according to an example. As shown in FIG. 13, the method includes steps S1301 and S1302.

In step S1301, first configuration information and second configuration information are transmitted to user equipment.

The first configuration information is configured to configure at least one first type of reference signal. The first type of reference signal is a reference signal capable of being disabled. The second configuration information is configured to configure a reference-signal-to-be-measured. The reference-signal-to-be-measured includes at least one first type of reference signal and at least one second type of reference signal.

The reference signal capable of being disabled is a reference signal to be dynamically disabled by the network device in a subsequent data transmission process. The number of the reference signals capable of being disabled is greater than or equal to 1.

In some examples, the first configuration information is configured to configure at least one spatial unit group. The spatial unit group is a candidate spatial unit group capable of being disabled. The spatial unit group includes at least one first type of reference signal.

The network device configures, through the second configuration information, the reference-signal-to-be-measured including at least one reference signal incapable of being disabled. Thus, the user equipment determines, according to the candidate spatial unit group capable of being disabled and the second configuration information that are received, the reference signal capable of being disabled, that is the first type of reference signal, in the reference-signal-to-be-measured.

In step S1302, a reference signal measurement result transmitted by the user equipment is received.

The reference signal measurement result includes a measurement result for at least one second type of reference signal. The second type of reference signal is a reference signal incapable of being disabled.

The reference signal incapable of being disabled is a reference signal not to be dynamically disabled by the network device in the subsequent data transmission process. The reference signal measurement result includes the measurement result for at least one reference signal incapable of being disabled.

For example, the measurement result may be L1-RSRP or may be L1-SINR.

In some examples, the measurement result for each second type of reference signal in the reference signal measurement result is greater than a set value.

The set value is an empirical value. The reference signal measurement result received by the network device merely includes a measurement result greater than the set value.

For example, the reference-signal-to-be-measured includes N second type of reference signals. Measurement results for M second type of reference signals are greater than the set value. In a case that M is greater than or equal to 1, the user equipment transmits the measurement results for the M second type of reference signals to the network device. In a case that M is equal to 0, the user equipment does not transmit the measurement result for the second type of reference signal to the network device, and the user equipment merely transmits the measurement result for the first type of reference signal to the network device in this case.

In the example of the disclosure, the network device informs, through the first configuration information, the user equipment of the reference signal capable of being disabled, and the user equipment can select and measure at least one reference signal incapable of being disabled when measuring the reference signal, and report a measurement result that satisfies a requirement to the network device. The network device can select at least one reference signal for data transmission from the reference signals incapable of being disabled after executing, after receiving the measurement result, an operation of disabling the reference signal, preventing the operation of disabling the reference signal from influencing the data transmission.

In another example, before step S1302, the method further includes transmitting third configuration information to the user equipment. The third configuration information is configured to configure the number of reference signals in the reference signal measurement result transmitted by the user equipment. The number of the reference signals in the reference signal measurement result is greater than 1, and the reference signals include at least one of the first type of reference signal or the second type of reference signal. That is, the network device indicates to the user equipment the number of all reference signals included in the measurement result to be reported by the user equipment irrespective of the type of such reference signals.

An example of the disclosure provides a method for receiving reference signal measurement result, and the method is performed by a network device. FIG. 14 is a flowchart of yet another method for receiving reference signal measurement result according to an example. As shown in FIG. 14, the method includes steps S1401, S1402 and S1403.

In step S1401, first configuration information and second configuration information are transmitted to user equipment.

Step S1401 has the same contents as step S1301, and will not be repeated.

In step S1402, fourth configuration information is transmitted to the user equipment.

The fourth configuration information is configured to configure the number of the second type of reference signals in a measurement result for the second type of reference signal in the reference signal measurement result.

In some examples, the number of the second type of reference signals in the measurement result for the second type of reference signal in the reference signal measurement result is L, and the number of the reference-signals-to-be-measured is K, where a range of L is:

$$1 \leq L \leq K .$$

The number of the second type of reference signals is determined by a plurality of methods. For example, the number of the second type of reference signals is determined according to the number of the reference-signals-to-be-measured and according to a set relation.

In an example, the set relation may be a linear functional relation. Alternatively, the set relation may be a nonlinear functional relation. Alternatively, the set relation is a one-to-one mapping relation. For example, K may equal 1 or 2 or 3 or 4, and when K=2 or 3, L=1; and when K=4, L=2.

In step S1403, a reference signal measurement result transmitted by the user equipment is received.

The reference signal measurement result includes the measurement result for at least one second type of reference signal. The number of the second type of reference signals in the measurement result for at least one second type of reference signal is the number indicated by the fourth configuration information.

In some examples, the measurement result for each second type of reference signal in the reference signal measurement result is greater than a set value.

The set value is an empirical value. The reference signal measurement result transmitted by the user equipment to the network device merely includes a measurement result greater than the set value, and the number of the reference signals is the number indicated by the fourth configuration information.

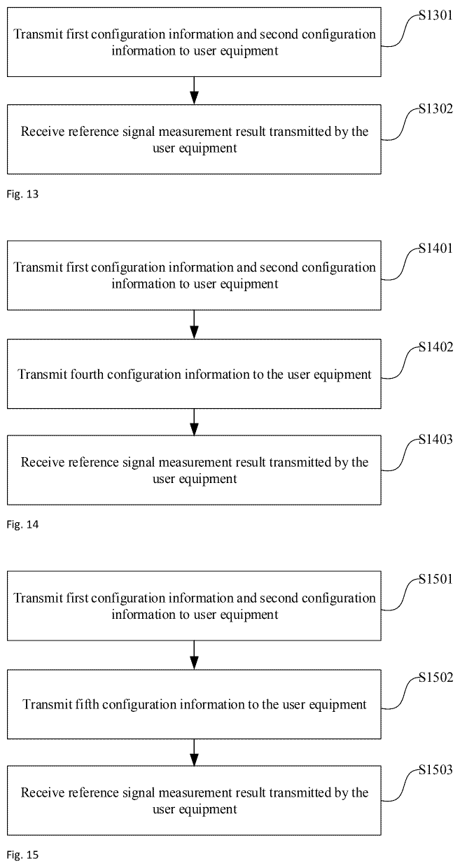

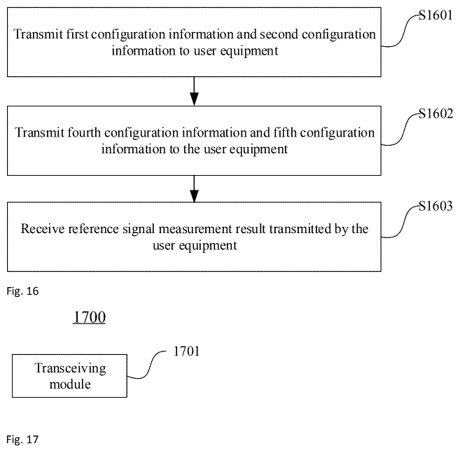

An example of the disclosure provides a method for receiving reference signal measurement result. FIG. 15 is a flowchart of yet another method for receiving reference signal measurement result according to an example. As shown in FIG. 15, the method includes steps S1501, S1502 and S1503.

In step S1501, first configuration information and second configuration information are transmitted to user equipment.

Step S1501 has the same contents as step S1301, and will not be repeated.

In step S1502, fifth configuration information is transmitted to the user equipment.

The fifth configuration information is configured to configure a report manner. The report manner is a report manner of a reference signal measurement result based on a reference signal group.

In step S1503, a reference signal measurement result transmitted by the user equipment is received.

In some examples, in response to the fifth configuration information, the reference-signals-to-be-measured are divided into two reference signal groups according to the number of the reference-signals-to-be-measured. The measurement result reported includes a measurement result for at least one reference signal group. For example, a measurement result for one reference signal group is reported, or measurement results for two reference signal groups are reported. The reported measurement result for the reference signal group includes a measurement result for at least one second type of reference signal.

An example of the disclosure provides a method for receiving reference signal measurement result, and the method is performed by a network device. FIG. 16 is a flowchart of still another method for receiving reference signal measurement result according to an example. As shown in FIG. 16, the method includes steps S1601, S1602 and S1603.

In step S1601, first configuration information and second configuration information are transmitted to user equipment.

Step S1601 has the same contents as step S1301, and will not be repeated.

In step S1602, fourth configuration information and fifth configuration information are transmitted to the user equipment.

The fourth configuration information is configured to configure the number of the second type of reference signals in a measurement result for the second type of reference signal in the reference signal measurement result. The fifth configuration information is configured to configure a report manner.

In some examples, the number of the second type of reference signals in the measurement result for the second type of reference signal in the reference signal measurement result is L, and the number of the reference-signals-to-be-measured is K, where a range of L is:

$$1 \leq L \leq K .$$

The number of the second type of reference signals is determined by a plurality of methods. For example, the number of the second type of reference signals is determined according to the number of the reference-signals-to-be-measured and according to a set relation.

In an example, the set relation may be a linear functional relation. Alternatively, the set relation may be a nonlinear functional relation. Alternatively, the set relation is a one-to-one mapping relation. For example, K may equal 1 or 2 or 3 or 4, and when K=2 or 3, L=1; and when K=4, L=2.

In some examples, the report manner is a report manner of the reference signal measurement result based on a reference signal group.

In step S1603, a reference signal measurement result transmitted by the user equipment is received.

In some examples, in response to the fifth configuration information, the reference-signals-to-be-measured are divided into two reference signal groups according to the number of the reference-signals-to-be-measured. The measurement result reported includes a measurement result for at least one reference signal group. For example, a measurement result for one reference signal group is reported, or measurement results for two reference signal groups are reported. The reported measurement result for the reference signal group includes a measurement result for at least one second type of reference signal, and the number of the second type of reference signals is the number indicated by the fourth configuration information.

An example of the disclosure further provides a communication device according to the same concept as the method examples. The communication device may have the functions of the user equipment 101 in the method examples, and is configured to execute steps that are provided by the method examples and executed by the user equipment 101. The function may be implemented by hardware, or by software or by executing corresponding software through hardware. The hardware or software includes one or more modules corresponding to the functions described in the disclosure.

In an example, the communication device 1700 shown in FIG. 17 may be used as the user equipment 101 involved in the method examples, and execute steps executed by the user equipment 101 in the method examples.

The communication device 1700 includes a transceiving module 1701.

The transceiving module 1701 is configured to receive first configuration information transmitted by a network device. The first configuration information is configured to configure at least one first type of reference signal. The first type of reference signal is a reference signal capable of being disabled.

The transceiving module 1701 is further configured to transmit a reference signal measurement result to the network device. The reference signal measurement result includes a measurement result for at least one second type of reference signal. The second type of reference signal is a reference signal incapable of being disabled.

In some examples, the transceiving module 1701 is further configured to receive second configuration information transmitted by the network device. The second configuration information is configured to configure a reference-signal-to-be-measured. The reference-signal-to-be-measured includes at least one first type of reference signal and at least one second type of reference signal.

In some examples, a measurement result for each second type of reference signal in the reference signal measurement result is greater than a set value.

In some examples, the transceiving module 1701 is further configured to configure at least one spatial unit group through the first configuration information. The spatial unit group is a candidate spatial unit group capable of being disabled. The spatial unit group includes at least one first type of reference signal.

In some examples, the transceiving module 1701 is further configured to receive fourth configuration information transmitted by the network device. The fourth configuration information is configured to configure the number of the second type of reference signals in the measurement result for the second type of reference signal in the reference signal measurement result.

In some examples, the number of the second type of reference signals is determined according to the number of the reference-signals-to-be-measured and according to a set relation.

In some examples, the transceiving module 1701 is further configured to receive fifth configuration information transmitted by the network device. The fifth configuration information is configured to configure a report manner. The report manner is a report manner of the reference signal measurement result based on a reference signal group.

The reference signal measurement result includes a measurement result for at least one reference signal group. The measurement result for the reference signal group includes the measurement result for at least one second type of reference signal.

In a case that the communication device 1700 is the user equipment, the communication device 1700 may have a structure as shown in FIG. 18. FIG. 18 is a block diagram of an apparatus 1800 for transmitting reference signal measurement result according to an example. For example, the apparatus 1800 may be a mobile phone, a computer, a digital broadcast terminal, a message transceiver device, a game console, a portable device, a medical device, a fitness device, a personal digital assistant, etc.

With reference to FIG. 18, the apparatus 1800 may include one or more of the following components: a processing component 1802, a memory 1804, a power component 1806, a multimedia component 1808, an audio component 1810, an input/output (I/O) interface 1812, a sensor component 1814, and a communication component 1816.

The processing component 1802 generally controls overall operations of the apparatus 1800, such as operations related to displaying, telephone calls, data communications, camera operations, and recording operations. The processing component 1802 may include one or more processors 1820 for executing an instruction, and completing all or some steps of the method described in the disclosure. In addition, the processing component 1802 may include one or more modules for interaction between the processing component 1802 and other components. For example, the processing component 1802 may include a multimedia module for interaction between the multimedia component 1808 and the processing component 1802.

The memory 1804 is configured to store various types of data to support the operation by the apparatus 1800. Instances of such data include instructions for any application or method operated on the apparatus 1800, contact data, phonebook data, messages, pictures, videos, etc. The memory 1804 may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk and an optical disk.

The power component 1806 energizes various components of the apparatus 1800. The power component 1806 may include a power management system, one or more power supplies, and other components associated with power generating, managing, and distributing for the apparatus 1800.

The multimedia component 1808 includes a screen providing an output interface between the apparatus 1800 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, swipe, and a gesture on the touch panel. The touch sensor may not only sense a boundary of a touch or swipe action, but also measure duration and a pressure associated with the touch or swipe operation. In some examples, the multimedia component 1808 includes at least one of a front-facing camera or a rear-facing camera. When the apparatus 1800 is in an operational mode, for example, a photographing mode or a video mode, at least one of the front-facing camera or the rear-facing camera may receive external multimedia data. Each of the front-facing camera and the rear-facing camera may be a fixed-focus optical lens system or have a focal length and an optical zoom capacity.

The audio component 1810 is configured to output and/or input an audio signal. For example, the audio component 1810 includes a microphone (MIC). When the apparatus 1800 is in an operational mode, such as a call mode, a recording mode or a voice recognition mode, the microphone is configured to receive an external audio signal. The audio signal received may be further stored in the memory 1804 or transmitted through the communication component 1816. In some examples, the audio component 1810 further includes a speaker configured to output the audio signal.

The I/O interface 1812 provides an interface between the processing component 1802 and a peripheral interface module. The peripheral interface module may be a keyboard, a click wheel, a button, etc. These buttons may include, but are not limited to: a home button, a volume button, a start button and a lock button.

The sensor component 1814 includes one or more sensors configured to provide state assessment in various aspects for the apparatus 1800. For example, the sensor component 1814 may detect an on/off state of the apparatus 1800, and relative location of the components. For example, the components are a display and a keypad of the apparatus 1800. The sensor component 1814 may also detect a location change of the apparatus 1800 or a component of the apparatus 1800, presence or absence of contact between the user and the apparatus 1800, orientation or acceleration/deceleration of the apparatus 1800, and a temperature change of the apparatus 1800. The sensor component 1814 may include a proximity sensor configured to detect the presence of a nearby object in the absence of any physical touch. The sensor component 1814 may further include an optical sensor, such as a complementary metal-oxide-semiconductor transistor (CMOS) or charge-coupled device (CCD) image sensor for use in an imaging application. In some examples, the sensor component 1814 may further include an acceleration sensor, a gyroscope sensor, a magnetic sensor, a pressure sensor or a temperature sensor.

The communication component 1816 is configured to facilitate wired or wireless communication between the apparatus 1800 and other devices. The apparatus 1800 may access a radio network based on a communication standard, such as WiFi, the 4th generation mobile communication technology (4G) or the 5th generation mobile communication technology (5G), or their combinations. In an example, the communication component 1816 receives a broadcast signal or broadcast related information from an external broadcast management system via a broadcast channel. In an example, the communication component 1816 further includes a near field communication (NFC) module to promote short-range communication. For example, the NFC module may be implemented based on a radio frequency identification (RFID) technology, an infrared data association (IrDA) technology, an ultra-wide band (UWB) technology, a Bluetooth (BT) technology, and other technologies.

In an example, the apparatus 1800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components for executing the method in the disclosure.

An example of the disclosure further provides a communication device according to the same concept as the method examples. The communication device may have the functions of the network device 102 in the method examples, and is configured to execute steps that are provided by the method examples and executed by the network device 102. The function may be implemented by hardware, or by software or by executing corresponding software through hardware. The hardware or software includes one or more modules corresponding to the functions described in the disclosure.

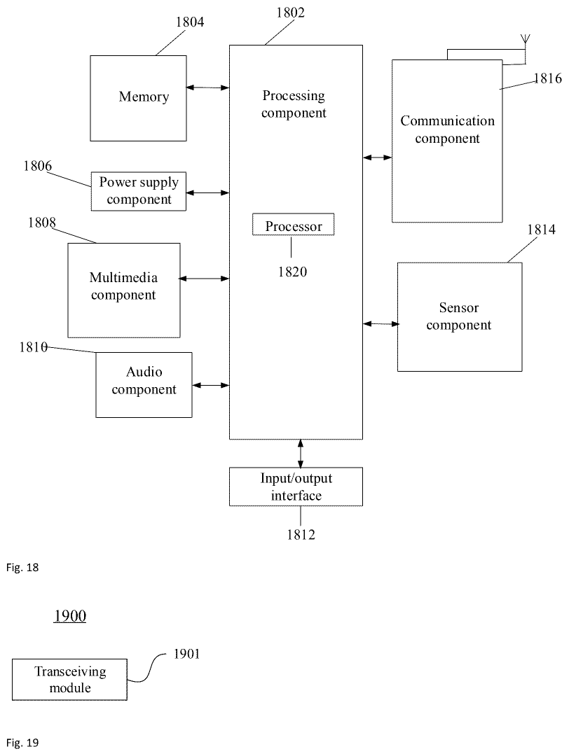

In an example, the communication device 1900 shown in FIG. 19 may be used as the network device 102 involved in the method examples, and execute steps executed by the network device 102 in the method examples.

The communication device 1900 shown in FIG. 19 includes a transceiving module 1901 configured to execute the steps executed by the network device 102 in the method examples.

The transceiving module 1901 is configured to transmit first configuration information to user equipment. The first configuration information is configured to configure at least one first type of reference signal. The first type of reference signal is a reference signal capable of being disabled.

The transceiving module 1901 is further configured to receive reference signal measurement result transmitted by the user equipment. The reference signal measurement result includes a measurement result for at least one second type of reference signal. The second type of reference signal is a reference signal incapable of being disabled.

In some examples, the transceiving module 1901 is further configured to transmit second configuration information to the user equipment. The second configuration information is configured to configure a reference-signal-to-be-measured. The reference-signal-to-be-measured includes at least one first type of reference signal and at least one second type of reference signal.

In some examples, a measurement result for each second type of reference signal in the reference signal measurement result is greater than a set value.

In some examples, the transceiving module 1901 is further configured to configure at least one spatial unit group through the first configuration information. The spatial unit group is a candidate spatial unit group capable of being disabled. The spatial unit group includes at least one first type of reference signal.

In some examples, the transceiving module 1901 is further configured to transmit fourth configuration information to the user equipment. The fourth configuration information is configured to configure the number of the second type of reference signals in the measurement result for the second type of reference signal in the reference signal measurement result.

In some examples, the number of the second type of reference signals is determined according to the number of the reference-signals-to-be-measured and according to a set relation.

In some examples, the transceiving module 1901 is further configured to transmit fifth configuration information to the user equipment. The fifth configuration information is configured to configure a report manner. The report manner is a report manner of the reference signal measurement result based on a reference signal group.

The reference signal measurement result includes a measurement result for at least one reference signal group. The measurement result for the reference signal group includes the measurement result for at least one second type of reference signal.

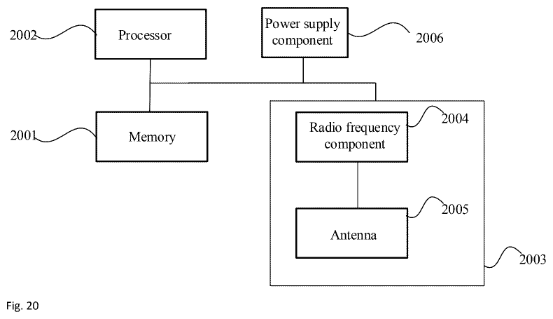

In a case that the communication device 1900 is the network device 102, the communication device 1900 may have a structure as shown in FIG. 20. As shown in FIG. 20, an apparatus 2000 includes a memory 2001, a processor 2002, a transceiving component 2003, and a power supply component 2006. The memory 2001 is coupled with the processor 2002 and may be configured to store programs and data for the communication device 2000 to implement various functions. The processor 2002 is configured to support the communication device 2000 to execute corresponding functions in the method, and the function may be implemented by invoking the program stored in the memory 2001. The transceiving component 2003 may be a wireless transceiver, and may be configured to support the communication device 2000 to receive signaling and/or data and transmit signaling and/or data through a radio. The transceiving module 2003 may also be referred to as a transceiving unit or a communication unit. The transceiving component 2003 may include a radio frequency component 2004 and one or more antennas 2005. The radio frequency component 2004 may be a remote radio unit (RRU), and may be configured to transmit a radio frequency signal and implement conversion between the radio frequency signal and a baseband signal. The one or more antennas 2005 may be configured to transmit and receive the radio frequency signal.

In a case that the communication device 2000 needs to transmit data, the processor 2002 may perform baseband processing on the data to be transmitted, and then output a baseband signal to the radio unit. The radio unit performs radio frequency processing on the baseband signal and then transmits the radio frequency signal in the form of electromagnetic waves through an antenna. When the data are transmitted to the communication device 2000, the radio unit receives the radio frequency signal through the antenna 2005, converts the radio frequency signal into the baseband signal, and outputs the baseband signal to the processor 2002. The processor 2002 converts the baseband signal into data and processes the data.

In the disclosure, the network device informs the user equipment of the reference signal capable of being disabled, and the user equipment can select and measure at least one reference signal incapable of being disabled when measuring the reference signal, and report a measurement result that satisfies a requirement to the network device. Thus, after executing an operation of disabling the reference signal, the network device can be informed of, according to the measurement result, the measurement result for the at least one reference signal incapable of being disabled, and select, according to the measurement result, a reference signal for data transmission from reference signals not disabled.

A person of ordinary skill in the art will readily conceive of other implementations of the disclosure after taking into account the description and implementing an invention disclosed. The disclosure is intended to cover any variation, use or adaptive change of the example of the disclosure, which follows general principles of the example of the disclosure and includes general knowledge or conventional technical means in the technical field not disclosed in the disclosure. The description and the examples are considered illustrative, and a true scope and spirit of the disclosure are indicated by the following claims.

It is to be understood that the example of the disclosure is not limited to precise structures described in the disclosure and shown in the accompanying drawings, and various modifications and changes can be made without departing from the scope of the disclosure. The scope of the example of the disclosure is limited by the appended claims.

### INDUSTRIAL APPLICABILITY

The user equipment is informed of, according to the first configuration information, the reference signal capable of being disabled, and can select and measure at least one reference signal incapable of being disabled when measuring the reference signal, and report a measurement result that satisfies a requirement to the network device. After executing an operation of disabling the reference signal, the network device can select, according to the measurement result, at least one reference signal for data transmission from the reference signals incapable of being disabled, preventing the operation of disabling the reference signal from influencing the data transmission.

1. A method for transmitting a reference signal measurement result, performed by user equipment, the method comprising:
receiving first configuration information transmitted by a network device, wherein the first configuration information is configured to configure at least one first type of reference signal, and the first type of reference signal is a reference signal capable of being disabled; and
transmitting a reference signal measurement result to the network device, wherein the reference signal measurement result comprises a measurement result for at least one second type of reference signal, and the second type of reference signal is a reference signal incapable of being disabled.

2. The method according to claim 1, further comprising:
receiving second configuration information transmitted by the network device, wherein the second configuration information is configured to configure a reference-signal-to-be-measured, and the reference-signal-to-be-measured comprises at least one first type of reference signal and at least one second type of reference signal.

3. The method according to claim 1, wherein
a measurement result for each second type of reference signal in the reference signal measurement result is greater than a set value.

4. The method according to claim 1, further comprising:
receiving third configuration information transmitted by the network device, wherein the third configuration information is configured to configure a number of reference signals in the reference signal measurement result transmitted by the user equipment, the number of the reference signals in the reference signal measurement result is greater than 1, and the reference signals include at least one of the first type of reference signal or the second type of reference signal.

5. The method according to claim 1, further comprising:
receiving fourth configuration information transmitted by the network device, wherein the fourth configuration information is configured to configure a number of the second type of reference signals in a measurement result for the second type of reference signal in the reference signal measurement result.

6. The method according to claim 5, wherein the number of the second type of reference signals is determined according to a number of reference-signals-to-be-measured and according to a set relation.

7. The method according to claim 1, further comprising:
receiving fifth configuration information transmitted by the network device, wherein the fifth configuration information is configured to configure a report manner, and the report manner is a report manner of the reference signal measurement result based on a reference signal group; and
the reference signal measurement result comprises a measurement result for at least one reference signal group, and the measurement result for the reference signal group comprises a measurement result for at least one second type of reference signal.

8. A method for receiving a reference signal measurement result, performed by a network device, the method comprising:
transmitting first configuration information to user equipment, wherein the first configuration information is configured to configure at least one first type of reference signal, and the first type of reference signal is a reference signal capable of being disabled; and
receiving a reference signal measurement result transmitted by the user equipment, wherein the reference signal measurement result comprises a measurement result for at least one second type of reference signal, and the second type of reference signal is a reference signal incapable of being disabled.

9. The method according to claim 8, further comprising:
transmitting second configuration information to the user equipment, wherein the second configuration information is configured to configure a reference-signal-to-be-measured, and the reference-signal-to-be-measured comprises at least one first type of reference signal and at least one second type of reference signal.

10. The method according to claim 8, wherein a measurement result for each second type of reference signal in the reference signal measurement result is greater than a set value.

11. The method according to claim 8, further comprising:
transmitting third configuration information to the user equipment, wherein the third configuration information is configured to configure a number of reference signals in the reference signal measurement result transmitted by the user equipment, the number of the reference signals in the reference signal measurement result is greater than 1, and the reference signals include at least one of the first type of reference signal or the second type of reference signal.

12. The method according to claim 8, further comprising:
transmitting fourth configuration information to the user equipment, wherein the fourth configuration information is configured to configure a number of the second type of reference signals in a measurement result for the second type of reference signal in the reference signal measurement result.

13. The method according to claim 12, wherein the number of the second type of reference signals is determined according to a number of reference-signals-to-be-measured and according to a set relation.

14. The method according to claim 8, further comprising:
transmitting fifth configuration information to the user equipment, wherein the fifth configuration information is configured to configure a report manner, and the report manner is a report manner of the reference signal measurement result based on a reference signal group; and
the reference signal measurement result comprises a measurement result for at least one reference signal group, and the measurement result for the reference signal group comprises a measurement result for at least one second type of reference signal.

15-16. (canceled)

17. An electronic device, comprising a processor and a memory; wherein
the memory is configured to store a computer program; and
the processor is configured to execute the computer program to:
receive first configuration information transmitted by a network device, wherein the first configuration information is configured to configure at least one first type of reference signal, and the first type of reference signal is a reference signal capable of being disabled; and
transmit a reference signal measurement result to the network device, wherein the reference signal measurement result comprises a measurement result for at least one second type of reference signal, and the second type of reference signal is a reference signal incapable of being disabled.

18. An electronic device, comprising a processor and a memory; wherein
the memory is configured to store a computer program; and
the processor is configured to execute the computer program to implement the method according to claim 8.

19. A non-transitory computer-readable storage medium, storing an instruction, wherein the instruction, when invoked and executed by a computer, causes the computer to execute the method according to claim 1.

20. A non-transitory computer-readable storage medium, storing an instruction, wherein the instruction, when invoked and executed by a computer, causes the computer to execute the method according to claim 8.

21. The method according to claim 1, wherein the first configuration information is configured to configure at least one spatial unit group, the spatial unit group is a candidate spatial unit group capable of being disabled and the spatial unit group includes at least one first type of reference signal.

22. The method according to claim 8, wherein the first configuration information is configured to configure at least one spatial unit group, the spatial unit group is a candidate spatial unit group capable of being disabled and the spatial unit group includes at least one first type of reference signal.
